(19) United States
(12) Patent Application Publication
(10) Pub. No.: US 2025/0256261 A1
(43) Pub. Date: Aug. 14, 2025

(54) POTASSIUM CARBONATE-BASED SORBENT FOR CO2 CAPTURE

(71) Applicant: University of North Dakota, Grand Forks, ND (US)

(72) Inventors: Xiaodong Hou, Grand Forks, ND (US); Abdelmalek Bellal, Grand Forks, ND (US); Junior Nasah, Grand Forks, ND (US); Johannes George van der Watt, Grand Forks, ND (US)

(21) Appl. No.: 19/048,491

(22) Filed: Feb. 7, 2025

Related U.S. Application Data
(60) Provisional application No. 63/551,293, filed on Feb. 8, 2024.

(51) Int. Cl. B01J 20/22; B01D 53/02

(52) U.S. Cl. CPC B01J 20/22; B01D 53/02; B01D 2253/20; B01D 2257/504

(57) ABSTRACT

A method for capturing CO₂ includes mixing pulverized coal in an alkali solution to produce a solution comprising humic acid, an alkali, and water, and capturing CO₂ according to a process comprising at least one of: (1) spray drying the solution with CO₂-containing gases to produce a solid carbonated sorbent comprising humic acid and carbonated alkali, (2) spray drying the solution with inert gas to produce a sorbent comprising humic acid and alkali species, and contacting the sorbent with CO₂-containing gases, and (3) spray drying the solution with inert gas to produce the sorbent, chemically activating the sorbent to produce an activated sorbent, and contacting the activated sorbent with CO₂-containing gases.

### CROSS-REFERENCE TO RELATED APPLICATION(S)

This application claims the benefit of U.S. Provisional Application No. 63/551,293 filed Feb. 8, 2024 for “A K2CO3-BASED SORBENT FOR CO2 CAPTURE” by X. Hou, A. Bellal, J. Nasah, and J. van der Watt.

### STATEMENT OF GOVERNMENT INTEREST

This invention was made with government support under Grant No. DE-FE-0026825/S001343 awarded by the Department of Energy National Energy Technology Laboratory. The government has certain rights in the invention.

### BACKGROUND

The present disclosure is directed generally to carbon dioxide (CO₂) capture and, more particularly, to adsorption-based CO₂ capture.

Post-combustion carbon capture technology, particularly in the context of large point source emissions such as power plants, is currently viewed as a feasible means to address the challenge of reducing global CO₂ emissions and fulfilling the objectives outlined in the Paris Agreement reached at the United Nations Climate Change Conference in 2015. Aqueous amine CO₂ capture technology is currently considered the benchmark and only commercially-adopted technology for coal power plants; however, it continues to present multiple challenges including high capture costs and concerns over aerosolized emissions of the amine solution. Cryogenic, membrane, and adsorbent-based processes have also been implemented on a large scale, however, with lower CO₂ capture capacities than amine technology.

Adsorption-based processes are considered an attractive and cost-efficient alternative for CO₂ capture in post-combustion applications. Various adsorbents have been investigated for CO₂ capture including carbon-based materials, zeolites, metal-organic frameworks, and oxides. Among them, alkali or alkaline metal-based adsorbents offer a great potential for large-scale implementation of regenerable CO₂ chemisorption, mainly because of their superior advantages, such as high theoretical adsorption capacity, effective CO₂ capture at high temperatures of 50-100° C., enhanced CO₂ uptake in the presence of water, and when compared to solvent-based CO₂ capture agents, lower sensible heat for regeneration. Particularly, potassium-based adsorbents can offer a cost-effective and energy-efficient path to post-combustion CO₂ capture and separation. The theoretical CO₂ adsorption capacity of pure potassium carbonate (K₂CO₃) is as high as 7.25 mmol CO₂/(g of K₂CO₃). However, mass transfer limitations lead to very low CO₂ adsorption capacity. A physical support is needed to disperse the K₂CO; and improve mass transfer, with methods such as wet impregnation on porous material reporting up to 50% by weight (wt. %) of K₂CO₃ dispersed on the porous material (Bararpour et al., 2019, “Investigation of the effect of alumina-aerogel support on the CO₂ capture performance of K2CO3,” Fuel, 242, 124-132; Karami et al., U.S. Pat. No. 11,376,560; Masoud et al., 2022, “Shedding Light on Solid Sorbents: Evaluation of Supported Potassium Carbonate Particle Size and Its Effect on CO₂ Capture from Air,” Industrial & Engineering Chemistry Research, 61(38), 14211-14221; Qin et al., 2014, “Effect of support material on the performance of K₂CO₃-based pellets for cyclic CO₂ capture,” Applied Energy, 136, 280-288; Wu et al., 2013, “K₂CO₃/Al₂O₃ for Capturing CO₂ in Flue Gas from Power Plants. Part 5: Carbonation and Failure Behavior of K₂CO₃/Al₂O₃ in the Continuous CO₂ Sorption-Desorption System.” Energy & Fuels, 27(8), 4804-4809). Considerable efforts have been devoted to increasing the amount of K₂CO₃ dispersed on the substrates by wet impregnation, however, exceeding 30-50 wt. % loading of K₂CO₃ negatively impacts the adsorption capacity as the higher loading results in a reduced surface area the formation of a thick film of K₂CO₃ that limits mass transfer (Zhao et al., 2012, K₂CO₃/Al₂O₃ for Capturing CO₂ in Flue Gas from Power Plants. Part 3: CO₂ Capture Behaviors of K₂CO₃/Al₂O₃ in a Bubbling Fluidized-Bed Reactor,” Energy & Fuels, 26(5), 3062-3068).

Several methods have been described for the preparation and use of aluminum oxide (Al₂O₃) as a support. These materials generally have a very high surface area and pore volume and are excellent adsorbents. Their adsorption capacities range from 1.5 to 4.03 mmol of CO₂/(g of adsorbent) and vary with K₂CO₃ loading, calcination temperature, and Al₂O₃ precursors. Even though a K₂CO₃/Al₂O₃ adsorbent has excellent CO₂ capture capacity, there are several disadvantages. The regeneration of this kind of adsorbent is energy-intensive, as high temperatures (260°-320° C.) are required to regenerate it by breaking the strong bond of the alloy formed during adsorption (carbonation): KAlCO₃(OH)₂. Recently focused research to overcome this problem includes generating Al₂O₃-modified support containing the KAlCO₃(OH)₂ phase for use in CO₂ capture (Lee et al., 2011, “Development of new alumina-modified sorbents for CO₂ sorption and regeneration at temperatures below 200° C.,” Fuel, 90(4), 1465-1470). To fabricate the support containing the alloy product, CO₂ is injected during the impregnation with K₂CO₃ at 100° C. This process will prevent the formation of alloys during carbonation and allow regeneration at temperatures lower than 200° C. However, the adsorption capacity of the adsorbent is at the lower end of this category of adsorbents (1.86 mmol of CO₂/g of adsorbent). Another disadvantage is that the cost of Al₂O₃ support is relatively high, which makes it a less cost-effective adsorbent for industrial applications. Finally, this type of adsorbent is limited to an optimal loading of K₂CO₃ that should be lower than 50 wt. %. A higher value than that results in a reduction of the surface area and mass transfer limitations, and a deterioration of adsorbent performance. K₂CO₃ can be supported on other metal oxides including zirconium dioxide (ZrO₂), titanium dioxide (TiO₂), or silicon dioxide (SiO₂). The formed KHCO₃ can easily be converted back to the original phase (K₂CO₃) at regeneration temperatures lower than 180° C. Even though the regeneration temperature of this kind of adsorbent is low, its adsorption capacity is poor compared to that of K₂CO₃/Al₂O₃. The adsorbent adsorption capacity is limited to 2 mmol of CO₂/g of adsorbent (Yi et al., 2007, “Continuous operation of the potassium-based dry sorbent CO₂ capture process with two fluidized-bed reactors,” International Journal of Greenhouse Gas Control, 1(1), 31-36; Zeng et al., 2023, “Comparative study on low-temperature CO2 adsorption performance of metal oxide-supported, graphite-casted K₂CO₃ pellets,” Separation and Purification Technology, 306, 122608). Furthermore, the large-scale application of K₂CO₃/TiO₂ and K₂CO₃/ZrO₂ is limited due to their high price. To minimize the cost of preparing the supported K₂CO₃, inexpensive SiO₂ has been proposed to be used as support. The current costs (2023) of 30 wt. % K₂CO₃/ZrO₂ and 30 wt. % K₂CO₃/TiO₂, calculated based on raw materials, are $80.4/kg and $47.9/kg. Meanwhile, 30 wt. % K₂CO₃/SiO₂ costs $1.7/kg. However, silica-supported K₂CO₃ showed a low adsorption capacity of 0.38 mmol of CO₂/(g of adsorbent) (Zeng et al., 2023).

High-temperature CO₂ adsorbents such as calcium oxide (CaO) and Lithium orthosilicate (Li₄SiO₄) are applicable only at very high carbonation and regeneration temperatures (600° C. and 750° C., respectively). These adsorbents are characterized by their excellent CO₂ capture. Li₄SiO₄ has exhibited an adsorption capacity of 3.1-3.7 mmol of CO₂/(g of adsorbent), however, the adsorbent is applicable only at temperatures higher than 600° C. (Zhang et al., 2020, K₂CO₃ promoted novel Li₄SiO₄-based sorbents from sepiolite with high CO₂ capture capacity under different CO₂ partial pressures,” Chemical Engineering Journal, 380, 122515). Hence, their application is limited to cement plants because the temperature of the treated flue gas from the coal-fired plant is about 450° C. Furthermore, such adsorbents are unstable. The higher regeneration temperature of Li₄SiO₄ (greater than 750° C.) can lead to the sintering of the adsorbent and can reduce the cyclic performance.

K₂CO₃ can be supported on activated carbon. Activated carbon possesses a greater surface area than mineral supports, is a relatively cheap material, and can be synthesized using less complex techniques, however, it exhibits poor CO₂ adsorption capacity which is lower than 2 mmol of CO₂/(g of adsorbent) (Meis et al., 2013, “Carbon Nanofiber-Supported K₂CO₃ as an Efficient Low-Temperature Regenerable CO₂ Sorbent for Post-Combustion Capture,” Industrial & Engineering Chemistry Research, 52(36), 12812-12818).

### SUMMARY

A method for capturing CO₂ includes mixing pulverized coal in an alkali solution to produce a solution comprising humic acid, an alkali, and water, and capturing CO₂ according to a process comprising at least one of: (1) spray drying the solution with CO₂-containing gases to produce a solid carbonated sorbent comprising humic acid and carbonated alkali, (2) spray drying the solution with inert gas to produce a sorbent comprising humic acid and alkali species, and contacting the sorbent with CO₂-containing gases, and (3) spray drying the solution with inert gas to produce the sorbent, chemically activating the sorbent to produce an activated sorbent, and contacting the activated sorbent with CO₂-containing gases.

In another aspect, a method of producing a solid sorbent for CO₂ capture includes mixing pulverized coal in an alkali solution to produce a solution, the solution comprising humic acid, an alkali, and water, and spray drying the solution to produce a sorbent comprising humic acid and alkali species, wherein the sorbent has a CO₂ adsorption capacity of at least 2.5 mmol/g activated sorbent.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a simplified flow diagram of processes for forming a CO₂ capture agent and CO₂ capture.

FIG. 2 is a scanning electron microscope image and particle size distribution graph of solid pre-activated sorbent produced by spray drying a solution.

FIG. 3A is a graphical representation of the chemical composition of the pre-activated sorbent within particle shell.

FIG. 3B is an annotated scanning electron microscope image of a cross-section of the pre-activated sorbent particle.

FIG. 4A is a graphical representation of the chemical composition of an activated sorbent within particle shell.

FIG. 4B is an annotated scanning electron microscope image of a cross-section of the activated sorbent particle.

FIG. 5 is a graphical representation of the effect of temperature, pH, and leaching duration changes from base conditions on the observed leaching yield of humic acid from raw coal.

FIG. 6A is a graphical representation of the adsorption capacity of a pre-activated sorbent determined using thermogravimetric analysis.

FIG. 6B is a graphical representation of the adsorption capacity of an activated sorbent determined using thermogravimetric analysis.

FIG. 7 is a bar and line graph illustrating the cyclic performance of activated sorbent.

FIGS. 8A and 8B are scanning electron microscope images of activated sorbent at cycle 2 and cycle 100, respectively.

FIG. 9 is a graphical representation of the thermogravimetric analysis curve and measured bench scale CO₂ desorption for activated sorbent.

FIG. 10A is a graphical representation of the differential temperature analysis curve for activated sorbent after sorbent humidification.

FIG. 10B is a graphical representation of the differential temperature analysis curve for activated sorbent after CO₂ adsorption.

FIG. 11 is a schematic of a bench-scale CO₂ adsorption apparatus.

FIG. 12 is a graphical representation of specific heat capacity of activated sorbent.

FIG. 13 is a simplified block flow diagram of activated sorbent manufacturing process.

FIG. 14 is a process flow diagram of a coal milling unit in the pre-activated and activated sorbent manufacturing process model.

FIG. 15 is a process flow diagram of a humic acid extraction unit in the pre-activated and activated sorbent manufacturing process model.

FIG. 16 is a process flow diagram of a spray drying unit in the pre-activated and activated sorbent manufacturing process model.

FIG. 17 is a process flow diagram of an adsorbent chemical activation unit in the activated sorbent manufacturing process model.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The present disclosure is directed to the development of high-performance sorbents or CO₂ capture agents comprising humic acid (HA) extracted from lignite or low-rank coal using an alkali solution. The humic acid serves as a substrate for alkali carbonation in CO₂ capture. As discussed further herein, the disclosed CO₂ capture agent is effective for CO₂ capture in three different forms: (1) a solution, (2) a solid sorbent, and (3) a chemically activated solid sorbent. The solution is a coal-extracted solution of humic acid, by an alkali such as potassium carbonate (K₂CO₃), and water. The solution can be spray dried in contact with hot CO₂-containing gases to capture the CO₂ and produce solid particles, referred to hereinafter as “carbonated sorbent.” In another configuration, the solution can be spray dried without contact with CO₂ to produce the solid sorbent for CO₂ capture. The solid sorbent (also referred to herein as “pre-activated sorbent”) is composed of humic acid and alkali species. In yet another configuration, the solid sorbent can be chemically activated to increase an alkali to carbon ratio, producing the activated solid sorbent (also referred to herein as “activated sorbent”) for CO₂ capture.

The CO₂ capture agents disclosed herein can be regenerated with low energy requirements “as-is” (solid form) or dissolved with water to form a liquid prior to regeneration, with relatively good cyclic stability in CO₂ adsorption capacity. The drying process disclosed herein allows for precise control of particle size and shape of the solid sorbents (pre-activated and activated) and alkali sites concentration on the surface of humic acid. The disclosed CO₂ capture agents have a low cost of production and are environmentally benign. The chemical composition of exhausted CO₂ capture agents or CO₂ capture agents that can no longer be regenerated as necessary to achieve a desired adsorption capacity can be used in fertilizer applications.

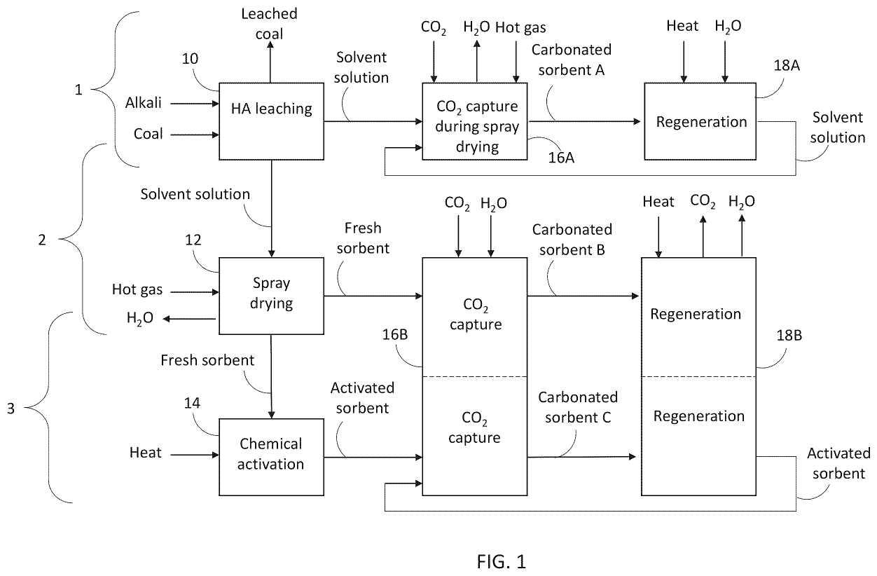

FIG. 1 is a simplified flow diagram of processes for forming a CO₂ capture agent and CO₂ capture. FIG. 1 shows the capture of CO₂ with the three forms of the CO₂ capture agent solution, solid sorbent (pre-activated sorbent), and chemically activated solid sorbent (activated sorbent)—in three capture processes 1-3. FIG. 1 shows humic acid leaching (step 10) to produce the solution, spray drying (step 12) to produce the pre-activated sorbent, chemical activation (step 14) to produce the activated sorbent, CO₂ capture (steps 16A and 16B) to produce carbonated sorbents A-C, and regeneration (steps 18A and 18B) to regenerate the CO₂ capture agents. In regenerating the CO₂ capture agent, CO₂ is released. The released CO₂ can be collected for use or for long-term storage or sequestration.

In step 10, humic acid is extracted from lignite coal. Humic acid content and extraction yield can vary widely depending on coal composition. In one non-limiting example, lignite can be dried to up to 100° C. to facilitate pulverizing to produce small (micron-sized) particles. The lignite can be pulverized by any particle size reduction device such as a ball mill or jet mill. In one non-limiting example, lignite can be pulverized to a particle size of less than 80 mesh (177 μm). In some embodiments, lignite can be pulverized to approximately 140 mesh (105 μm). The small size of lignite particles enhances the extraction process by generating a large contact area between the lignite solid and the extraction liquid.

Humic acid is extracted from the lignite with an alkali solution. The alkali solution can be K₂CO₃, which is an active ingredient for CO₂ capture. As discussed further herein, humic acid yield can be highly dependent on the composition of the lignite. Experimental data suggests that lignite sources with low carbon content and high carboxyl groups may be preferred candidates for humic acid extraction. Carboxyl groups increase the solubility of humic acid in the alkaline solution and can thereby increase extraction yield.

The lignite particles can be added to the alkali solution and stirred to allow humic acid dissolution. In an exemplary embodiment, the alkali solution can be 0.3 M K₂CO₃, which is mixed with lignite at a ratio of 1:10 lignite to solution. The pH of the alkali solution should be at least 9 to dissolve the humic acid. The lignite can be mixed with the prepared alkali solution by stirring. In some embodiments, heat can be added to increase the extraction yield of humic acid. In one non-limiting example, the lignite is mixed with the alkali solution for approximately 4 hours at a temperature ranging from 45° C. to 50° C. Heating the solution to 47° C. was shown to increase the humic acid yield by 22.4% (FIG. 4). Increasing the extraction temperature can increase the yield of humic acid by affecting the dissolution rate. Increasing the extraction temperature above the disclosed 47° C. may further increase the humic acid yield, however, the cost associated with additional heat duty should be considered. Furthermore, it is noted that humic acid exhibits poor thermal stability at higher temperatures.

The added lignite with K₂CO₃ forms potassium cations in a hydroxide state that can replace the protons in the humic acid molecules, resulting in their activation and dissolution. This alkali extraction technique transforms insoluble humic acids into soluble salts, such as potassium humate. Following dissolution, the precipitates (leached coal) can be separated out (e.g., via centrifuge), leaving the solution to be used for CO₂ capture, as illustrated in FIG. 1.

In process 1, the solution, comprising humic acid (in the form of a soluble salt), alkali (K₂CO₃), and water can be used for CO₂ capture in step 16A. The solution can be contacted with CO₂-containing gases using methods known in the art to capture the CO₂ and form solid particles shown in FIG. 1 as carbonated sorbent A. For example, the solution can be spray-injected into a drying chamber by pressurizing it with CO₂ containing gases through a two-fluid type of nozzle. Hot gas (e.g., air) is injected simultaneously in co-current flow with the atomized solution to dry it. Droplets of the solution are contacted with the CO₂-containing gas and capture the CO₂. Water in the droplets can be evaporated by hot gas at temperatures ranging from 140-150° C. in the CO₂ capture process, leaving carbonated sorbent A, which is in solid form.

The solution can be used to capture CO₂ from a gas stream of pure CO₂ or gas streams with any fraction of CO₂. In the examples disclosed further herein, the CO₂-containing gases comprise approximately 15% by volume CO₂, which is similar to the flue gas from a coal-fired power plant. Other gas constituents can include, for example, oxygen and nitrogen, but are not limited thereto. The CO₂-containing gas can be at room temperature (i.e., around 25° C.). In some embodiments, the CO₂-containing gas may be injected as hot gas.

The solution can be regenerated following CO₂ capture in step 18A. In regeneration, heat is added to release CO₂ from carbonated sorbent A. A minimum regeneration temperature of approximately 140° C. is sufficient to release the CO₂, which yields a significant reduction in the regeneration energy requirements as compared to the prior art amine solvent capture systems and other solid chemical sorbents. The measured latent heat of CO₂ and bicarbonate H₂O released is approximately 70-80 kJ/(mol of CO₂ adsorbed).

In one embodiment, carbonated sorbent A can be dissolved in water and subsequently heated to the regeneration temperature to produce a CO₂ gas stream and the regenerated solution. Alternatively, dry carbonated sorbent A can be heated to cause desorption of CO₂, producing a CO₂ gas stream and a solid sorbent. However, the solid sorbent needs to be dissolved in water to form the initial solution for a subsequent cycle of CO₂ capture and regeneration. Use of the solution has been demonstrated to have a CO₂ capture capacity (also referred to herein as “adsorption capacity”) of approximately 1 mmol/(g solid sorbent).

The method of regeneration can be selected based on material handling systems of a CO₂ capture system. Liquid regeneration can be preferred for CO₂ capture systems designed with material handling systems for liquid transport. Solid regeneration can be preferred for CO₂ capture systems designed with material handling systems for solid transport. CO₂ capture using the disclosed solution can be conducted using methods known in the art for solvent-based CO₂ capture.

In process 2, the solution produced in step 10 can be spray dried (step 12) without contact with CO₂ to produce the solid sorbent. The spray drying procedure aims to continuously dry the solution and produce solid sorbent particles of specified morphology selected to increase CO₂ capture capacity. Spray drying can be conducted via spray drying techniques known in the art. Spray drying operational parameters provided herein are used to produce particles of the solid sorbent of a defined size, shape, uniformity, and chemical composition identified as providing increased CO₂ capture capacity. As discussed further herein, enhanced CO₂ capture can be achieved with particles of varying morphologies and chemical compositions. It will be understood by one of ordinary skill in the art that the spray parameters of the exemplary embodiment disclosed herein may be adapted for large-scale commercial operations to produce particles of substantially the same morphology and chemical composition or particles with substantially similar or acceptable CO₂ adsorption capacity without departing from the scope of the invention.

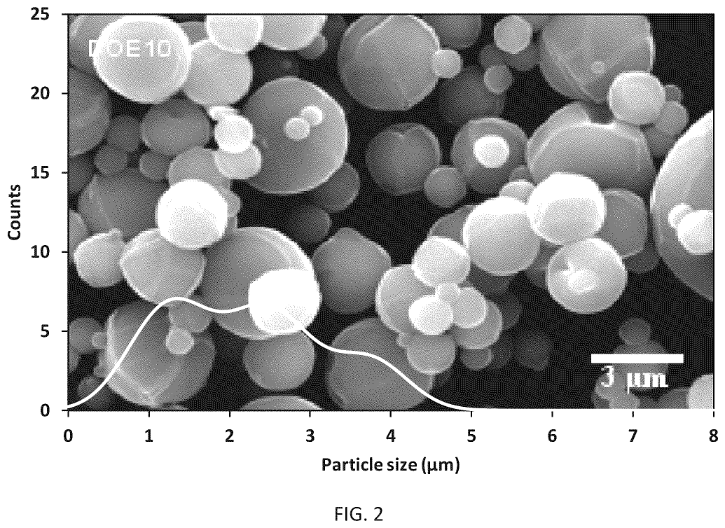

In an exemplary embodiment, the solid sorbent particles can be substantially hollow, spherical particles having a substantially smooth, dense or non-porous shell and ranging in size from approximately 0.5 to 5 m. FIG. 2 is a scanning electron microscope (SEM) image and particle size distribution graph of the solid sorbent produced using the spray parameters of one exemplary embodiment. The surface area of the solid sorbent was surprisingly low (about 1 m²/g) so the physisorption capacity of the sorbent is negligible. The formation of substantially hollow particles reduces the overall weight of the solid sorbent and increases the CO₂ capture capacity per gram solid sorbent. A smooth, non-porous outer shell surface can promote surface functionalization for CO₂ capture with a thin layer of K₂CO₃ (i.e., available K₂CO₃ is not filling micropores open to the surface).

The chemical composition of the solid sorbent is defined by the chemical composition of the solution. As previously discussed, in an exemplary embodiment, a 0.3 M K₂CO₃ solution with a liquid to solid lignite ratio of 10:1 is used to produce the solid sorbent in the spray drying process. This solution composition has been demonstrated to produce solid sorbent with effective CO₂ capture capacity.

In a first step of the spray drying process, the solution can be pumped through an atomizing nozzle to pressurize the solution with compressed gas and form a spray of fine droplets. The compressed gas can be air. The solution is sprayed into a drying chamber with heated air. The heated air can be supplied by a fan to dry the aqueous droplets formed in the spray. Solution homogeneity can be maintained by continuously agitating the solution in a vessel before spraying. The droplets formed by the atomizer are transported by the hot air from the spray nozzle to the receiving vessel, passing a cyclone, which removes the dried particles from the air stream through vortex separation. The sorbent particle morphology can be controlled by adjusting multiple operational parameters, including but not limited to, spray nozzle type, solvent volume (liquid to lignite ratio of the solution), fan speed, pumping speed, and temperature. The control of solid sorbent morphology and its effect on CO₂ capture capacity should not limit the recovery rate of the spray dryer.

Spray drying can be conducted with an atomizing spray nozzle. In one non-limiting embodiment, spray drying can be conducted with a two-fluid nozzle spray dryer. Spray drying of fine particles is typically accomplished using a two-fluid nozzle in which liquid is sprayed via a nozzle and surrounded by atomizing gas issuing from an annulus. In an exemplary embodiment, a two-fluid nozzle with a 1 mm atomizer can be used to produce substantially spherical solid sorbent particles ranging in size from approximately 0.5 μm to 5 μm. The spray nozzle design can be selected, as known in the art, for producing a desired particle morphology (e.g., size and shape). The spray drying process parameters, including pumping speed and inlet hot air temperature, can substantially influence the particle morphology and, thereby, the CO₂ adsorption capacity. In an exemplary embodiment, the spray drying conditions can include a K₂CO₃ concentration of 0.3 mol/l, and an inlet hot gas temperature of 195-215° C.

In step 16B, the solid sorbent produced via spray drying can be used to capture CO₂, converting solid sorbent to carbonated sorbent B. The CO₂ capture process can be conducted using known solid adsorption technologies (e.g., fluidized bed, powdered injection or packed column reactor). The solid sorbent is humidified prior to CO₂ capture to activate K₂CO₃ sites. In the carbonation reaction, K₂CO₃ reacts with CO₂ from a CO₂-containing gas stream in the presence of water to adsorb the CO₂. The product of the reaction is potassium bicarbonate (KHCO₃). The solid sorbent can be humidified external to the reactor. In an exemplary embodiment, the solid sorbent is humidified by exposure to water vapor inside a closed, pressure vessel at 110-120° C. temperature for an appropriate time between 2 to 8 minutes, depending on steam saturation with pressure build-up, to target up to 20 wt. % moisture content. Humidification can be determined based on a change in the weight of the solid sorbent. The humidified solid sorbent can be placed in the reactor for CO₂ capture.

The CO₂-containing gas can be injected into the reactor at a volumetric flow rate suitable for the reactor. In some embodiments, low gas flow rates can be used to prevent entrainment of the solid sorbent particles. Carbonation can occur at room temperature (approximately 25° C.). The reactor temperature and gas flow can be kept constant during a CO₂ capture process. The time period for CO₂ capture or carbonation can vary depending on the adsorbent bed saturation and CO₂ concentration. CO₂ can be measured in an exhaust flow to monitor the carbonation process. Following carbonation, the stream of CO₂-containing gas can be discontinued. Use of the solid sorbent has been demonstrated to have a CO₂ capture capacity of approximately 1 mmol/g solid sorbent.

In step 18B, the solid sorbent can be regenerated in a desorption process. Desorption can be performed by increasing the temperature of the reactor or carbonated sorbent B in a separate vessel (referred to herein as “regenerator”). In an exemplary embodiment, the temperature can be increased to at least 140° C., which is suitable for causing CO₂ desorption from the disclosed solid sorbent, formed from humic acid and K₂CO₃. Heat can be applied to carbonated sorbent B using any of a variety of methods known in the art. A purge gas (e.g., steam) can be used to sweep the desorbed CO₂. The released CO₂ exhausted from the regenerator can be separated from the purge gas and collected for utilization or long-term storage or sequestration. Water can also be released in the regeneration process. CO₂ can be separated from water by cooling followed by flash separation, for industrial scale CO₂ capture operations. Following regeneration, the solid sorbent can be re-humidified for use in a subsequent CO₂ capture and regeneration cycle. The solid sorbent can be removed from the reactor for humidification. Multiple CO₂ capture and regeneration cycles can be conducted with the fresh sorbent. Solid sorbent that no longer demonstrates a desired CO₂ capture capacity is environmentally benign and can be disposed of. In some applications, the solid sorbent can be used as fertilizer.

In process 3, the solid sorbent produced by spray drying the solution in step 14 can be chemically activated to increase CO₂ capture capacity. Chemical activation is conducted by applying heat to the solid sorbent. Heating the material initiates a chemical reaction between the humic acid and the alkali (K₂CO₃) and increases the alkali-to-humic acid ratio at the surface of the particles.

Chemical activation can be conducted in two steps. In a first step of the activation process, solid or pre-activated sorbent particles can be heated to approximately 750° C. under an inert atmosphere (e.g., argon) to remove all tarry materials and carbonize the solid sorbent. Heating can be conducted in a furnace. In an exemplary embodiment, the reactor can be heated from room temperature (approximately 25° C.) to 750° C. at a ramp rate of approximately 5° C./min to the final temperature of 750° C. The temperature can be held at 750° C. for approximately 2 hours.

Following carbonization, the sorbent particles can be cooled to room temperature. Following cooling, a second activation step can be performed. In the second activation step, the sorbent particles can be heated to 750° C. in a flow of CO₂ to recover the K₂CO₃ sites on the humic acid base. In an exemplary embodiment, the reactor can be heated from room temperature (approximately 25° C.) to 750° C. at a ramp rate of approximately 5° C./min to the final temperature of 750° C. The temperature can be held at 750° C. for approximately 1 hour. The flow of CO₂ at high temperature chemically reduces K₂O formed in the first activation step to K₂CO₃. The second activation step recovers the K₂CO₃ and prevents self-ignition of the material at room temperature in ambient air. If the second activation step is not performed, the carbonized sorbent could burn when exposed to air.

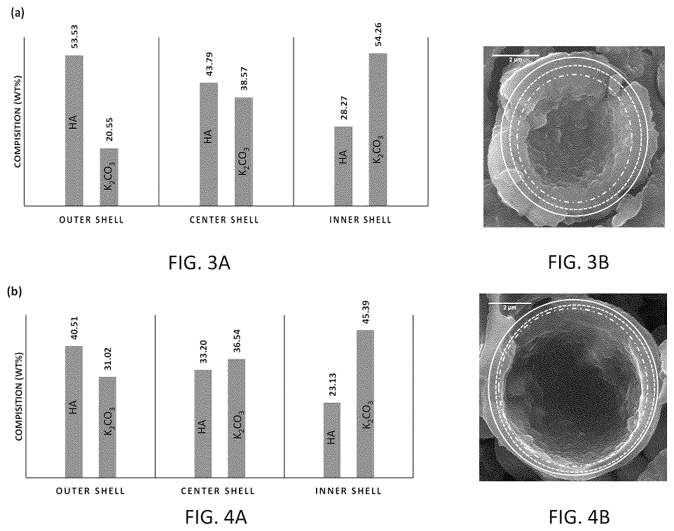

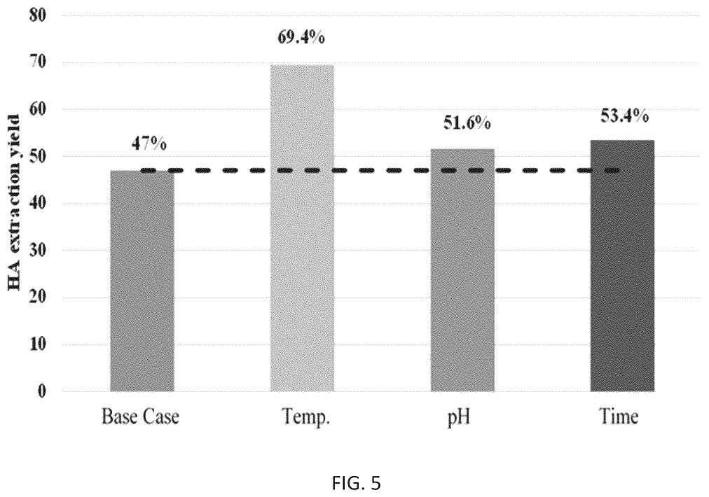

FIGS. 3A and 3B illustrate the chemical composition of solid sorbent (before activation). FIGS. 4A and 4B illustrate the chemical composition of activated sorbent. FIGS. 4A and 5A are bar graphs of the humic acid and K₂CO₃ in each of an outer shell, center shell, and inner shell of the pre-activated sorbent and activated sorbent particle, respectively. FIGS. 3B and 4B are SEM images of a cross-section of the pre-activated sorbent particle and activated sorbent particle, respectively, annotated to illustrate the outer shell (solid line), center shell (dashed line), and inner shell (dash-dot line). FIGS. 3A, and 4B provide a visualization of the mass composition differences within the adsorbent shell of the pre-activated sorbent and activated sorbent.

The results of FIGS. 3A, 3B, 4A, and 4B were obtained from averaging the mass calculation at several points from the investigated circled area. Covering large areas lowered the measurement error introduced by the electron beam size and roughness of the surface. It can be seen from the depicted results of both the pre-activated sorbent and activated sorbent, that K₂CO₃ to humic acid mass ratio in the outer shell of the particles increases after activation. The activation step decomposes the humic acid from the microsphere's surface, causing more K₂CO₃ exposure and improving surface area availability for the CO₂ gas, which likely contributes to the high capture performance of the activated sorbent. The disclosed method has been demonstrated to result in a very high K₂CO₃ loading in the activated sorbent of up to 61 wt %. The high K₂CO₃ loading can increase CO₂ capture capacity.

In step 16C, the activated sorbent can be used to capture CO₂, converting activated sorbent to carbonated sorbent C. Step 16C can be the same as or substantially similar to step 16B for CO₂ capture with pre-activated sorbent. The activated sorbent is humidified as previously described prior to CO₂ capture to activate the sorbent.

The CO₂-containing gas can be injected into the reactor at a suitable volumetric flow rate of approximately 150 ml/min per 50-100 grams of sorbents. Carbonation of the activated sorbent can occur at room temperature (approximately 25° C.). The reactor temperature and gas flow can be kept constant during a CO₂ capture process. The time period for CO₂ capture or carbonation can vary depending on the adsorbent bed saturation and CO₂ concentration. CO₂ can be measured in an exhaust flow to monitor the carbonation process. Following carbonation, the stream of CO₂-containing gas can be discontinued. Use of the activated sorbent has been demonstrated to have a CO₂ capture capacity of greater than 4 mmol/g solid sorbent, providing a significant improvement over the solution and pre-activated sorbent CO₂ capture capacities.

In step 18C, the solid sorbent can be regenerated in a desorption process. The desorption process of step 18C can be the same as or substantially similar to the desorption process disclosed in step 18B. Desorption can be performed by increasing the temperature of the reactor or carbonated sorbent B in a regenerator. In an exemplary embodiment, the temperature can be increased to a minimum of 140° C., which is suitable for causing CO₂ desorption from the disclosed activated sorbent, formed from humic acid and K₂CO₃. Heat can be applied to carbonated sorbent C using any of a variety of methods known in the art. A purge gas (e.g., steam) can be used to remove the desorbed CO₂. The released CO₂ exhausted from the reactor can be separated from the purge gas and collected for utilization or long-term storage or sequestration. Water can also be released in the regeneration process. CO₂ can be separated from water by cooling followed by flash separation for industrial scale CO₂ capture operations. Following regeneration, the activated sorbent can be re-humidified for use in a subsequent CO₂ capture and regeneration cycle. Multiple CO₂ capture and regeneration cycles can be conducted with the activated sorbent with cyclic stability in CO₂ capture. As discussed further herein, adsorption capacity is diminished over a number of cycles. Activated sorbent that no longer demonstrates a desired CO₂ capture capacity is environmentally benign and can be disposed of.

The disclosed K₂CO₃-based CO₂ capture agents can be used for CO₂ capture with cyclic stability. Precise control of particle size of the solid sorbents (pre-activated and activated) can be provided through the disclosed spray drying process and a high alkali concentration (e.g., over 60 wt %) can be achieved to increase CO₂ capture capacity. The disclosed CO₂ capture agents have low regeneration energy requirements and cost of production, as discussed further herein, are environmentally benign, and can be used for fertilizer applications. Activated sorbent has demonstrated a high CO₂ capture capacity of greater than 4 mmol/g sorbent, which makes it an attractive candidate for large-scale CO₂ capture applications.

### EXPERIMENTAL DATA AND DISCUSSION

Humic Acid Leaching from Lignite

In one non-limiting example, lignite mined from the Twin Buttes seam at Freedom Mine served as the source for humic acid leaching. Before extraction, the samples underwent a drying process at 100° C. in an oven to remove all water content and were then pulverized to achieve an 80-mesh size. A ball mill was employed to achieve a desired particle size of 140 mesh. Reducing the lignite particle size is beneficial for the leaching procedure due to the increased contact surface between the solid lignite and the liquid. The alkaline solution was formulated by dissolving a specified concentration of K₂CO₃ in a predetermined volume of H₂O, maintaining a 1:10 ratio between lignite and the solution. The lignite was subsequently combined with the formulated alkali solution and agitated using a magnetic stirrer. When coal is introduced to K₂CO₃, it generates potassium cations in a hydroxide (OH) form, which can substitute the protons (H+) in humic acid molecules, leading to their activation and solubilization. This alkali leaching method converts the insoluble humic acid into soluble compounds like potassium humate (Fatima et al., 2021, “Extraction and Chemical Characterization of Humic Acid from Nitric Acid Treated Lignite and Bituminous Coal Samples,” Sustainability, 13(16), 8969). Both humic and fulvic acids were derived from lignite, yet humic acid represented a substantial portion of the extracted humic substances (Garcia et al., 1993, “Effects of the extractants on the characteristics of a humic fertilizer obtained from lignite.” Bioresource Technology, 43(3), 221-225). The mixture was subjected to centrifugation at 4,500 rpm for a duration of 5 minutes. The upper liquid layer, or supernatants, were cautiously decanted, leaving behind the humins that had settled at the base of the centrifuge tubes.

The flocculating agent polydiallyldimethylammonium (PDDA) was incorporated into the solution to aid in the precipitation of humins. However, its effect on improving the purification was non-remarkable, hence, removed from the synthesis protocol.

Leonardite was initially used as a leaching raw material. The sensitivity of humic humic acid yield to the change in leaching conditions was investigated to set the optimal leaching procedure that can be applied later to lignite. Leonardite is a highly oxidized ore formed during the carbonization process of lignite containing the humic substance. Leonardite has lower ash content and higher leaching yield than lignite, making it an adequate candidate for visualizing the minor changes accompanied by a single variation in the leaching parameters. A series of sensitivity analysis experiments assessed the impacts of temperature, alkalinity, time, leonardite particle size, stirring speed, and liquid-to-solid ratio. The base case was prepared by adding leonardite to a K₂CO₃ solution (0.25M) with a liquid-to-solid ratio equal to 10:1. The solution was stirred for 12 hours at room temperature. A more substantial base (potassium hydroxide (KOH)) was added to the K₂CO₃ solution to change the pH. The first screening of the varied parameters revealed that the variation in leonardite particle size, stirring speed, and liquid-to-solid ratio did not impact the leaching yield. The sensitivity analysis was narrowed to cover only temperature, alkalinity, and time. Different lignite sources were tested after setting the general procedure using the optimized parameters for humic acid leaching from leonardite to define the best representative material with the highest leaching yield, which was used for the remainder of the study.

Results from the optimization tests for the respective factors are shown in FIG. 5. Temperature had the most pronounced effect on leaching yield. Heating the leaching solution to 47° C. resulted in a yield increase of 22.4% compared to the base case. A further temperature increase could result in a higher yield, which would be expensive given the increased energy penalty. Humic acid exhibits poor thermal stability at higher temperatures (Garcia et al., 1994, “Effects of the extraction temperature on the characteristics of a humic fertilizer obtained from lignite,” Bioresource Technology, 47(2), 103-106). Reducing the leaching duration from 12 to 4 hours yielded a surprisingly higher yield than the base case. Adding a more substantial base, KOH, resulted in a yield enhancement of 4.6%. Overall, the effect of various leaching conditions followed the order temperature>duration>pH.

Four lignite samples were collected from different mining sources and used to determine which type has a higher leaching yield. Table 1 summarizes the leaching results for the lignite coals. A K₂CO₃ concentration lower than the base case was initially used during comparative humic acid leaching. The Freedom Mine lignite had the highest humic acid yield at lower leaching conditions.

TABLE 1
Humic acid leached from different lignite sources.

| | Leaching parameters | | | |
|---|---|---|---|---|
| Test No | Lignite source | K₂CO₃ concentration | Yield | Ash content |
| 1 | Coyote Creek Mine | 0.1M | 3.8% | 29.0% |
| 2 | Falkirk Mine | 0.1M | Unsuccessful^{a} | 17.6% |
| 4 | Freedom Mine | 0.1M | 8.8% | 49.3% |
| 5 | Freedom Mine | 0.2M | 39% | 49.3% |

^{a}Poor humic acid leaching.

The humic acid leaching yield was strongly correlated to the lignite source, possibly due to the variation in ash content level, which dilutes the humic acid presence in lignite. An ash content analysis for humic acid was performed using the ASTM 3174-12 standard to investigate this assumption. The study indicated an inverse correlation between ash content and humic acid leaching yield (Table 1).

The elemental analyses for the Coyote Creek and Freedom Mines lignites revealed that the Freedom Mine lignite exhibited higher O:C (Table 2), suggesting an abundance of carboxyl groups, which facilitates humic acid leaching with the basic K₂CO₃ solution. The elementary analysis of the extracted humic acid revealed a low C and N content and a relatively high H and O content, which matches the trend in the Freedom Mine lignite composition.

TABLE 2
Elemental analysis of lignite mined from different
sources and the extracted humic acid (atomic %)

| Lignite source | C (%) | N (%) | H (%) | O (%) | H:C^{a} | O:C^{a} | N:C^{a} |
|---|---|---|---|---|---|---|---|
| Thin Buttes Seam | 27.91 | 0.56 | 2.53 | 17.58 | 9.06 | 62.99 | 2.00 |
| H bed Seam | 45.6 | 1.1 | 3.88 | 29.91 | 8.51 | 65.59 | 2.41 |
| Coyote Creek | 52.27 | 0.87 | 4.37 | 25.51 | 8.36 | 48.80 | 1.66 |
| Extracted Humic acid | 24.24 | 0.47 | 2.33 | 14.83 | 9.61 | 61.18 | 1.94 |
| from Thin Buttes Seam | | | | | | | |

^{a}Atomic ratio × 100.

### Effect of Activation on the CO₂ Capture Capacity

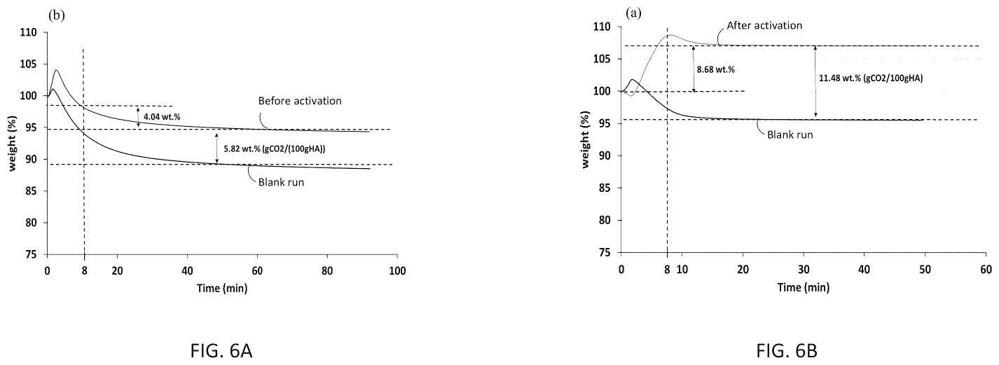

FIGS. 6A and 6B are graphical representations of the effect of activation on the adsorption capacity of the sorbent determined using thermogravimetric analysis (TGA). A high adsorption capacity was achieved by activating the adsorbent at high temperatures. The capacity improved from 0.9 to 2 mmol of CO₂/(g of sorbent) after activation at the adsorption half-time of 4 minutes. The measured CO₂ uptake was at the minimum adsorption limit since a portion of weight gain was hidden by moisture desorption from the sample during the test using TGA. An overall weight gain was observed after 8 minutes from the start of the flow. In contrast, no weight gain occurred for the non-activated adsorbent, and a smaller capture capacity was observed after 50 minutes of adsorption. The capacity of the active adsorbent suggested more than a two-fold increase in performance over the inactivated sample, with adsorption capacities ranging from 2 to 2.6 mmol of CO₂/(g of sorbent).

A cross-section analysis of the particles before and after activation exhibited an increase in the K₂CO₃ to humic acid mass ratio in the outer shell of the particles after activation, as shown in FIGS. 3A, 3B, 4A, 4B. The activation step decomposed the humic acid from the microsphere's surface, causing more K₂CO₃ exposure and improving surface area availability for the CO₂ gas, which likely contributed to the activated adsorbent's higher performance than the original, non-activated adsorbent.

### Cyclic Performance

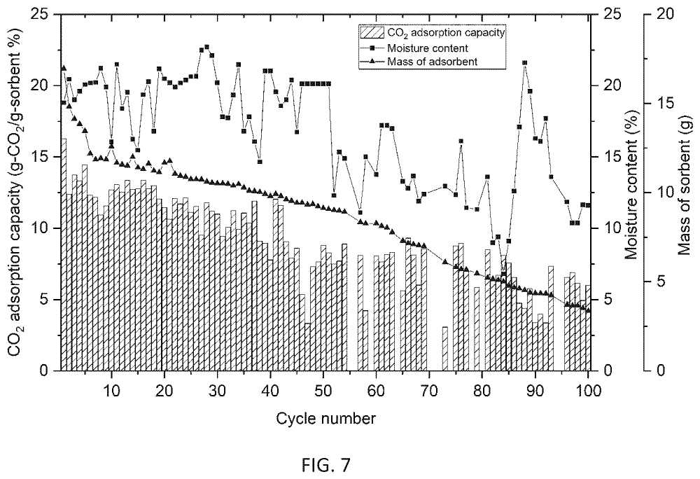

FIG. 7 depicts the cyclic performance of the newly activated adsorbent tested using a bench scale CO₂ capture unit. The results of the first 40 cycles were promising, as low loss in capacity was observed. The recorded adsorption capacity for the first cycle was 3.7 mmol of CO₂/(g of sorbent) and only dropped to 2.7 mmol of CO₂/(g of sorbent) after 41 cycles. This corresponds to a loss in capacity of only over 25%, which was better than that of the adsorbent cycled with the inert bed material exhibiting a reduction in the capacity of 51%. However, a continuous decline in adsorption capacity was observed and attributed to a drop in the moisture content, primarily caused by mass loss of sorbent during cycling. 80% of the starting sample mass was lost after 100 cycles. The fluctuation in capacity observed during cycling was attributed to either the changes in adsorbent packing within the bed during loading/unloading of the sample before each cycle or the change in moisture content.

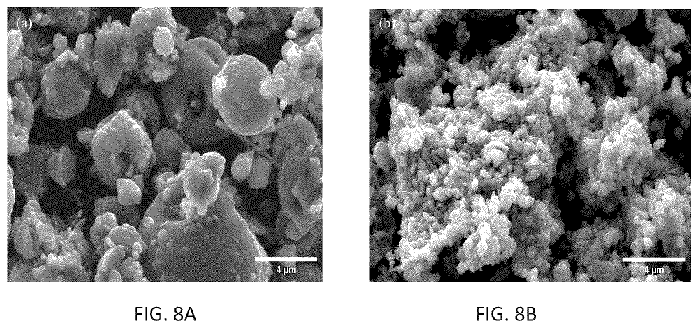

The effectiveness of humidifying the adsorbent was strongly correlated to the mass of the adsorbent. At small masses, it became difficult to control the moisture content of the adsorbent, resulting in over-humidification of the sample. A controlled drying step of the humidified sample was required to remove the excess moisture. This step was introduced in the second half of cycling (after 50 cycles) when the mass of the adsorbent was lower than 9 g. This drying step is believed to have drastically changed the texture of the adsorbent, as shown in FIGS. 8A and 8B. The cycled adsorbent is now composed of agglomerated, large, and irregular particles, most likely caused by the intermediate drying step. This change in particle morphology is considered the primary cause of the faster loss of adsorption capacity, as the adsorbent's available active capture surface area was reduced.

### Regeneration Energy

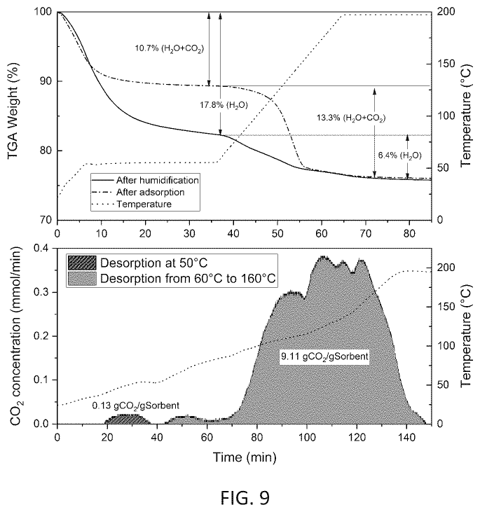

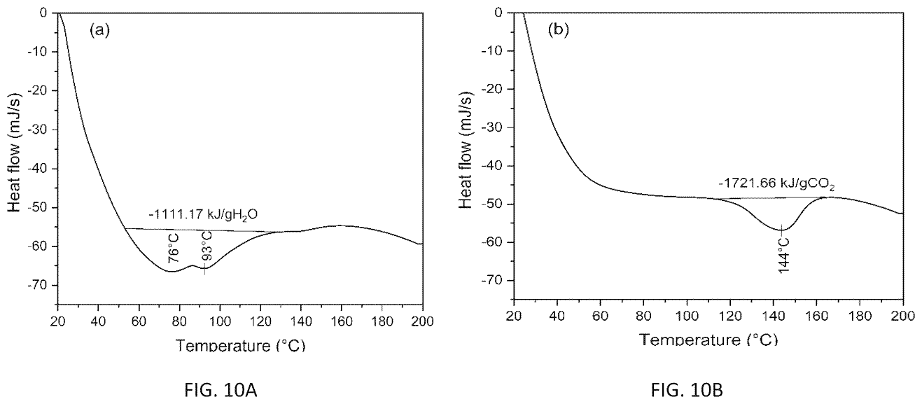

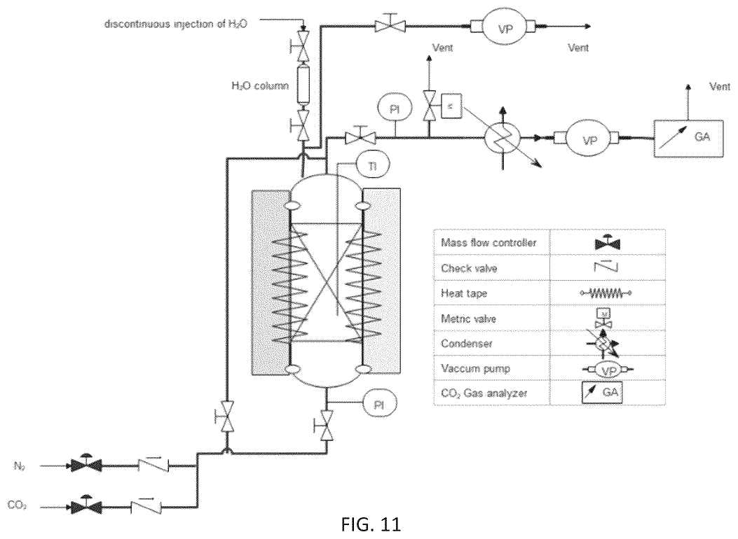

The TGA and bench scale desorption were employed to conduct a more comprehensive investigation into the thermal decomposition mechanisms of the adsorbent (FIG. 9) and correlated to heat flow obtained by differential temperature analysis (DTA), as depicted in FIGS. 10A and 10B. FIG. 9 is a graphical representation of the TGA curve and measured bench scale CO₂ desorption for activated sorbent. FIG. 10A is a graphical representation of the DTA curve for activated sorbent after sorbent humidification. FIG. 10B is a graphical representation of the DTA curve for activated sorbent after CO₂ adsorption. The decomposition temperature was programmed with a ramp from room temperature to 50° C., held for 10 minutes to match the experiment conducted on a bench scale and allow for the complete desorption of CO₂ from the surface of K₂CO₃/HA, and then increased to 200° C. at a ramping rate of 5° C./min. The thermal regeneration of the adsorbent using TGA results in simultaneous desorption of H₂O and CO₂, making it impractical to determine the amount of CO₂ desorbed and the latent heat of desorption using only TGA and DTA. The connected CO₂ analyzer to the bench scale CO₂ desorption unit (shown in FIG. 11) could provide accurate measurements of desorbed CO₂. The measured CO₂ amount per adsorbent mass was subtracted from the TGA analysis to obtain a representative amount of H₂O desorbed during the decomposition of KHCO₃. Both TGA curves, after adsorbent humidification and after CO₂ adsorption, show two decomposition plateaus in the temperature range below 200° C. The first plateau, which appears in the TGA curve at 50° C., is presumably due to adsorbent dehydration and desorption of physically bounded CO₂. The second plateau of the TGA curves is attributed to KHCO₃ decomposition process. The desorbed amount of CO₂ at 50° C. is relatively small (0.03 mmol of CO₂/(g of sorbent)), indicating the presence of weak physical interaction between CO₂ molecules and the surface of sorbent. The full desorption of CO₂ (2.1 mmol of CO₂/(g of sorbent)) occurs at higher temperatures, which is mainly attributed to the chemical bonding of CO₂ to the pre-hydrated K₂CO₃ (K₂CO₃·1.5H₂O). It can be seen from FIG. 9 that the weight loss for the sample after adsorption is less than that of the sample after humidification at 50° C.; neglecting the poor physisorption of the CO₂, this demonstrates that 10.7 wt % of H₂O in a form of K₂CO₃·1.5H₂O did not react with CO₂.

The findings from the DTA in FIG. 10A are consistent with the outcomes derived from the TGA analysis, showing two merged peaks at 76° C. and 93° C., which correspond to the decomposition of unreacted K₂CO₃·1.5H₂O. A total latent desorption heat equals 1111.17 kJ/gH₂O (20 kJ/mol of H₂O). The pre-humidification K₂CO₃·1.5H₂O has an important function in the adsorption process, which can react with CO₂ at low reaction enthalpy.

The heat flow analysis of the sample after adsorption (FIG. 10B) has shown a peak at 144° C. corresponding to the latent heat of KHCO₃ decomposition into K₂CO₃, H₂O, and CO₂ products. The calculated latent heat of CO₂ desorption, considering the mass balance of TGA and bench scale analysis, is 75.7 kJ/molCO₂.

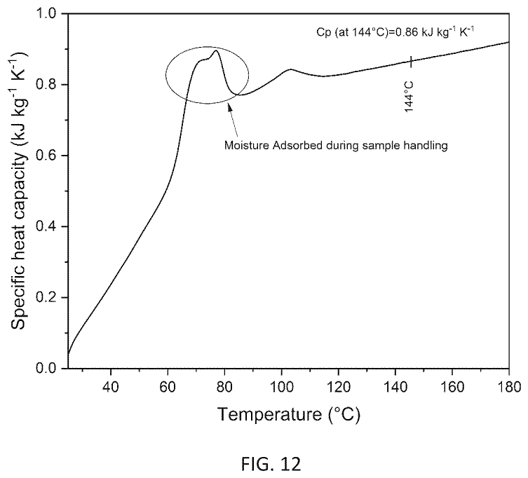

For better identification of adsorbent energy demand for CO₂ desorption, sensible heat must be determined. FIG. 12 depicts the measured value of specific heat (Cp) versus temperature. The small peak at 70° C. is attributed to the latent heat of H₂O desorption, which was adsorbed during sample handling. Considering 1 kg of the adsorbent with a heat capacity of 0.86 kJ kg⁻¹ K⁻¹ has an adsorption capacity of 2.1 mmol of CO₂/(g of sorbent) produces 2.1 mol of CO₂, the calculated sensible heat is 38.49 kJ/molCO₂. The total thermal energy required for the CO₂ desorption process includes sensible and latent heat, corresponding to 114.19 kJ/molCO₂.

### Commercialization Analysis

Little work was done in the literature covering the price of adsorbents based on techno-economic evaluation. Up-scaling design and economic evaluation of the adsorbent manufacturing process fill the knowledge gap and benchmark the application of the developed adsorbent.

### Process Description

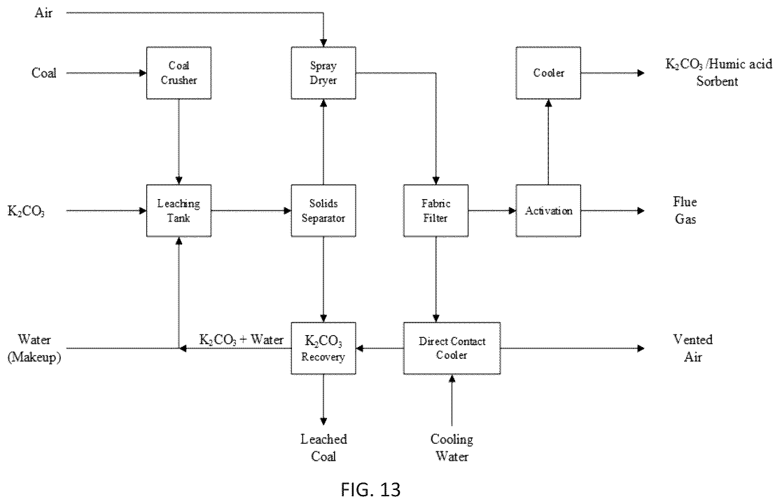

FIG. 13 shows a process flow diagram of the adsorbent manufacturing process. The process design was developed using Aspen Plus® software. A generalized description of the process is as follows. At first, 40 tonnes/hr of lignite coal is crushed to smaller particle sizes. The coal was dried during crushing to remove 20 tonnes of water. As the crushed coal is fed to the leaching unit, K₂CO₃, and water were also introduced to the same unit at mass flow rates of 8.2 tonnes/hr and 200 tonnes/hr, respectively. In the leaching reactor, the coal is mixed with the K₂CO₃ and water with a residence time of 4 hours, followed by the insoluble (humins) filtration. The leachate of K₂CO₃ and humic acid produced through the leaching (˜194 tonnes/hr) is pumped to the spray drying unit for further processing. Similarly, humins are washed in another tank with clean water to recover 2.2 tonnes/hr of K₂CO₃, recycled to the leaching reactor's inlet to reduce the makeup amount. 2.1 tonnes/hr of humins cake with 45% (mass) of moisture content is disposed of as waste. Afterward, the pressurized leachate is sprayed with a two-fluid nozzle to form a small droplet of solution and dried in contact with hot air at 240° C. The solids are separated from the air using a fabric filter. As the separated hot air (at 125° C.) carries a large amount of water vapor, a cooling process is conducted by exchanging the heat with cold air supplied by the forced draft fan following a direct contact cooler (quencher). The fed cooling water to the quencher is withdrawn from the cooling tower. 43 wt % of water vapor was recovered as a liquid and recycled to the inlet of the leaching reactor. 14.8 tonnes/hr of spray-dried solid sorbent activated in a rotary kiln at 750° C. The flue gas is burned to provide the necessary heat to the chemical activation process. At the end of the process chain, 10 tonnes/hr of activated sorbent is produced and sold to the CO₂ capture facilities. The capacity of the adsorbent manufacturing process was based on capturing 95% of CO₂ emitted by the Case B11B sub-critical power plant from the National Energy and Technology Laboratory (NETL) report (Schmitt et al., 2022, Cost and Performance Baseline for Fossil Energy Plants Volume 1: Bituminous Coal and Natural Gas to Electricity. netl.doe.gov. https://netl.doe.gov/energy-analysis/details). A conservative CO₂ adsorbent capacity of 2 mmol of CO₂/(g of sorbent) was considered for determining the adsorbent circulation rate. This amounts to approximately 7300 tonnes/hr solid circulation rate, with an adsorbent replacement rate of 10 tonnes/hr, corresponding to a minimum cyclic performance of 730 cycles.

Adsorbent manufacturing consists of four main process steps, including (1) coal handling and milling, (2) humic acid leaching, (3) spray drying, and (4) adsorbent calcination. The sections of the simulations will be discussed next.

### Coal Handling and Milling

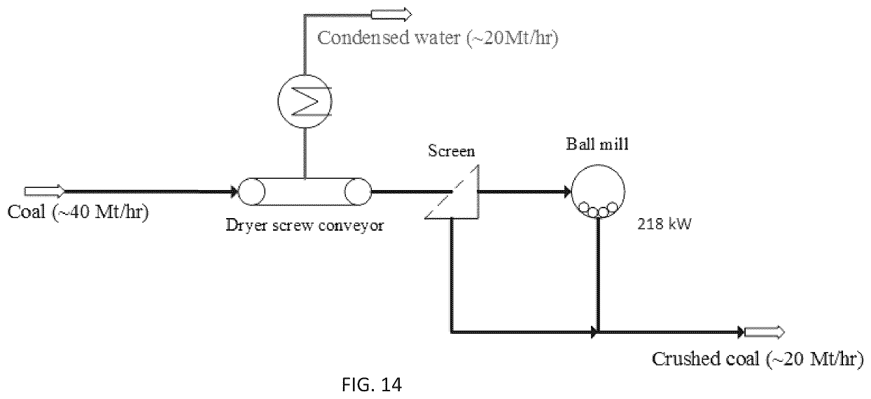

The simulation has modeled coal crushing to have a small particle size mentioned herein. FIG. 14 is a process flow diagram of a coal milling unit in the pre-activated and activated sorbent manufacturing process model. According to the plant design, as seen in FIG. 14, coal is first screened and then introduced to a ball mill. In the milling process, non-loss of coal mass was assumed, and the milling was equipped with an in-situ coal drying. Hence, 50 wt % of the moisture content was recovered and pumped to the leaching unit. Power required for coal handling and milling has been accounted for in the energy needed to run the plant.

### Humic Acid Extraction

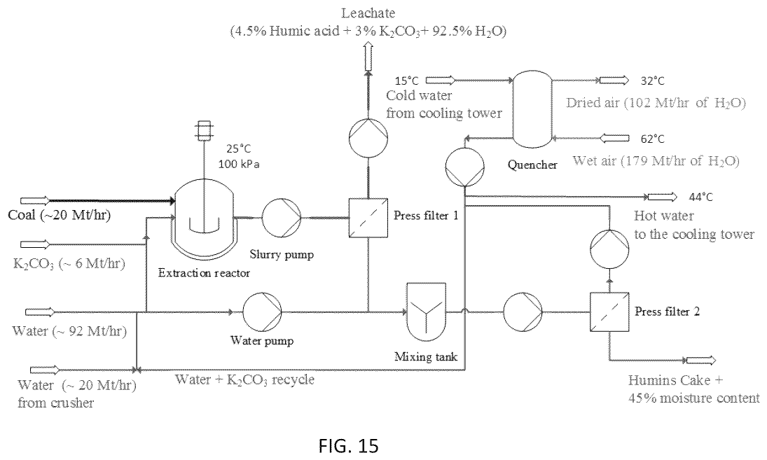

The performance of the leaching process largely depends on several parameters, including the leaching temperature and duration. As reported in previous work, these parameters are essential in achieving high humic yield and were chosen based on experimental optimization. However, Although the empirical work proved that a high temperature of 47° C. resulted in better yield, the simulation of the leaching process was conducted at room temperature. An optimal leaching residence time of 4 hours was used to size the mixing reactor. FIG. 15 is a process flow diagram of a humic acid extraction unit in the pre-activated and activated sorbent manufacturing process model. FIG. 15 shows the process's humic acid leaching, leachate recovery, and humins washing sections. The leaching reactor is considered the CSTR model. Once the coal is fed to the reactor, it reacts with the K₂CO₃ solution and decomposes into humic acid and humins. Then, the slurry mixture was pumped to a leachate separation section. The output streams of the press filtration are liquid leachate containing humic acid and K₂CO₃ and humins cake. Based on lab experiments, 10% of the K₂CO₃ solution stays with humins cake after leachate separation, which was considered in the actual process. The next step includes pumping the leachate to the spray drying unit using a slurry pump; on the other side, separating K₂CO₃ lost with humins by washing the cake in a mixing tank and pumping it to another filter press. For K₂CO₃ recovery, clean water was used to wash humins in the mixing tank. The soaked humins cake was transported in a belt conveyor to a managed waste disposal area, and the recovered K₂CO₃ was recycled with washing water and the condensed water from the quencher. The quencher columns were specified to operate at a counter-courant and equipped with 7 trays to cool the water vapor-saturated air from the spray drying unit. Undoubtedly, effective utilization of humins discharged by the leaching unit as a fertilizer can reduce the emission of solid waste to the environment by the process and cut down the transportation cost and landfill costs of humins.

### Spray Drying

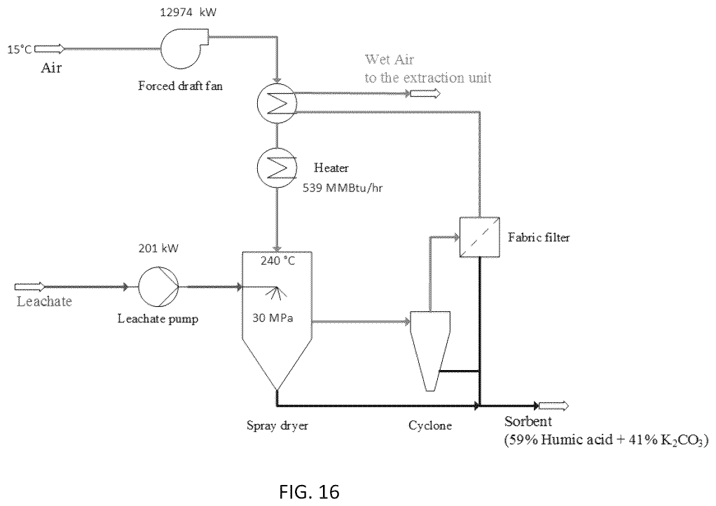

FIG. 16 is a process flow diagram of a spray drying unit in the pre-activated and activated sorbent manufacturing process model. As shown in FIG. 16, the leachate of the leaching unit was pressurized using a slurry pump to 30 bars to be sprayed inside the drying chamber. The required electric power to run the pump is 201 kW. On the other hand, 3.8 m³/hr of air (at 30° C.) was compressed from 1 to 1.1 bar using a forced draft fan. The required electric power to compress the gas is 12.9 MW. Then, the air flowed through a heat exchanger to gain 222.3 MMBtu/hr of heat from the spray dryer outlet. The air temperature should be at 240° C. to completely dry the liquid sprays with a specified equilibrium moisture content close to zero. Hence, the required heat to meet the drying specification and increase the air temperature to 240° C. is 539.4 MMBtu/hr, which could be provided by burning natural gas. The dried droplets of leachate solution were filtrated from the air using a fabric filter and convoyed to the chemical activation unit while the hot air coming out of the spray dryer was saturated with water vapor and needed to be cooled in a series of heat exchangers. Shell-tube heat exchanger followed by a direct contact cooler stated in the leaching section.

### Adsorbent Chemical Activation

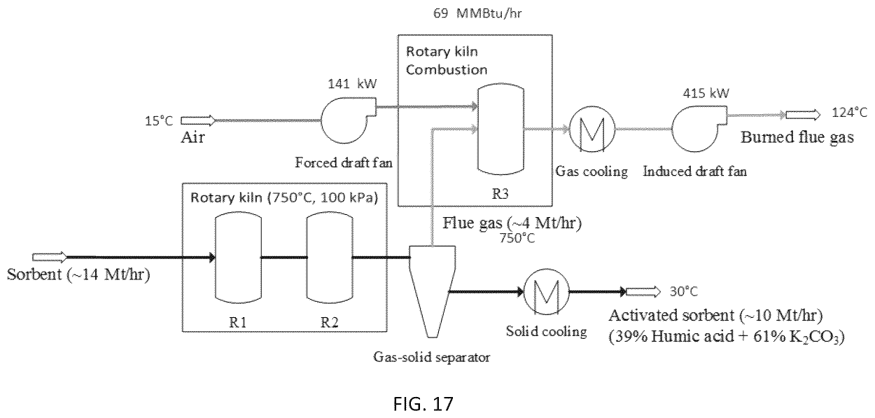

FIG. 17 is a process flow diagram of an adsorbent chemical activation unit in the activated sorbent manufacturing process model. FIG. 17 shows the chemical activation unit of 14.8 tonnes/hr K₂CO₃/HA sorbent. This adsorbent was first decomposed to conventional components (O₂, N₂, C, S, and H₂) in the Ryield reactor since the flue gas was modeled with the RGibbs reactor. This RGibbs reactor model simulated the gas products' equilibrium composition for HA's activation reaction by minimizing the Gibbs free energy. It explains the requirement of the two reactors that decompose the humic acid into elements because RGibbs cannot calculate the Gibbs free energy of nonconventional components like humic acid. To create a self-heating system of the process, the air was supplied to another RGibbs reactor to burn the defined composition of off-gas from the RGibbs reactor at 750° C. and generate the required heat by the unit (69 MMBtu/hr). In dynamic mode, equivalent thermal energy from burning natural gas is necessary to start the process. During conventional combustion, a forced draft fan and an induced draft fan were used to flow the combustible gases, which were considered in determining the annual operating cost. It will be discussed in the results section. In the actual process, the whole simulated process is represented by a single rotary kiln with indirect heating and integrated solid conveying and cooling systems.

### Adsorbent Manufacturing Cost

The cost of the tested CO₂ adsorbent prepared from coal-derived material (humic acid) was firmly estimated. According to the mineral resource inventory of the State of North Dakota, the commodity price of potash is $980/t. The market price of the lignite was referred to the average sale price of lignite to two power station, including Antelope valley and Leland Olds stations plus the cost of transportation from Freedom Mine to the reception station, which totalize at $24/t. This material is cost-effective due to its inexpensive raw materials and straightforward manufacturing processes. Cost considerations are paramount in this context since a substantial quantity of adsorbent will be needed to effectively capture CO₂ from the flue gas emitted by coal-fired power plants. Given that a single coal plant with 650 MW of net power emits approximately 875 kgCO₂/MWh (Schmitt et al., 2022), the demand for adsorbent on such a scale is staggering. Therefore, using an economical CO₂ adsorbent represents a notable advantage in our approach. The base calculation of the manufacturing cost was performed on a chemical composition of the synthesized material consisting of 61% of K₂CO₃ loading. The experimented adsorption capacity of the first cycle was 3.7 mmolCO2/(g of sorbent), and after 100 of cyclic adsorption/desorption, the capacity declined to 2 mmolCO₂/g of sorbent. Using a basic calculation of the adsorbent cost from raw material cost and assuming the adsorption capacity is equal to the minimum value, for each 1 kg of CO₂ adsorbed, 11.36 kg of adsorbent is required. According to the initial experiment setup, the mass ratio of K₂CO₃ to lignite coal in the leaching process is 41:100, and to produce 1 kg of adsorbent, 2 kg of coal lignite and 0.8 kg of K₂CO₃ are used in the synthesizing process. The raw materials cost roughly $0.83/kg of adsorbent ($9.45/kg CO₂ captured). If the adsorption capacity exceeds the conservative capacity, the adsorbent's price becomes cheaper.

Based on the same loading and adsorption capacity, a more comprehensive investigation of the adsorbent cost was performed by evaluating the manufacturing process cost. This investigation was performed mainly to provide strong evidence that not only the low cost of the feedstock reduced the adsorbent price but also the synthesizing method played a vital role in improving the economic profit towards the production of low-price adsorbent. Therefore, a techno-economic assessment of the adsorbent manufacturing plant was conducted to assess the financial viability of the new adsorbent characteristics. The transformational technologies are highly desired to achieve new 95% CO2 purity goals at a lower adsorbent price than $2/kg. The adsorbent price was calculated from respective capital, variable, fixed operating, and fuel costs. Table 3 shows the breakdown of capital costs for the adsorbent manufacturing process. Capital costs (CAPEX) were calculated from the components named equipment cost, material cost, labor cost, bare erected cost, engineering procurement and construction cost, and process and project contingencies. It can be seen that major costs incurred for the facility were from spray drying equipment and the activation process. Spray drying equipment covered 34.5% of the total plant cost (TPC), whereas the activation process covered 45% of the TPC. Table 4 shows the capital charges, fixed and variable operating costs, and fuel costs for the first year of production. The capital charges represent 8.86% of the total as spent cost, equal to $8.7M/year. The sum of fixed and variable costs is $74.9M/year. The plant operating cost (OPEX) is calculated to be $96.9M per year. OPEX determines the sale price of the adsorbent. In this case, it is estimated at $1293/tonne of adsorbent. The price is meager compared to the reported K₂CO₃ adsorbents in literature with competitive capture performances, where extensive scale application of K₂CO₃/TiO₂ and K₂CO₃/ZrO₂ is limited due to the high selling price. The raw material costs of these two adsorbents are $80.4/kg and $47.9/kg, respectively. If the capital CAPEX evaluation is done, the price could reach much larger values because of the added complexity of the synthesizing method.

TABLE 3
Capital cost summary for activated sorbent manufacturing process.

| | | | | |
|---|---|---|---|---|
| | | | Construction | Total Plant |
| | | | Equipment Total | Cost |
| Item No. | Description | Equipment Cost | Cost | (TPC)/CAPEX |

Coal Handling and Milling

| | | | | |
|---|---|---|---|---|
| 1.1 | Conveyor, lignite | $73,175 | $6,890 | $296,576 |
| 1.2 | Crusher, Lignite 4-stage Roller | $126,875 | $9,187 | $437,932 |
| | Subtotal | $200,050 | $16,078 | $734,508 |

HA leaching

| | | | | |
|---|---|---|---|---|
| 2.1 | Storage Tank, K₂CO₃ | $1,024,855 | $27,562 | $2,247,930 |
| 2.2 | Tank, Leaching, Mixing | $1,883,143 | $34,452 | $3,682,920 |
| | Subtotal | $2,907,998 | $62,014 | $5,930,850 |

Leachate Recovery

| | | | | |
|---|---|---|---|---|
| 3.1 | Filter press, separate leachate | $146,531 | $6,890 | $402,942 |
| 3.2 | Pump, leachate | $55,576 | $276 | $88,204 |
| 3.3 | Pump, leached coal slurry | $76,790 | $1,837 | $162,138 |
| | Subtotal | $278,896 | $9,003 | $653,284 |

K₂CO₃ recovery

| | | | | |
|---|---|---|---|---|
| 4.1 | Filter, polish, separate K₂CO₃, | $100,622 | $6,890 | $336,374 |
| | and water | | | |
| 4.2 | Pump, water wash, and | | | |
| | recoverable | $9,088 | $551 | $28,416 |
| 4.3 | Tank, water wash, Mixing | $627,714 | $27,562 | $1,672,076 |
| 4.4 | Pump, humins slurry | $11,890 | $276 | $24,859 |
| 4.5 | Conveyor, humins | $48,928 | $6,890 | $261,419 |
| | Subtotal | $798,243 | $42,169 | $2,323,144 |

Spray Drying

| | | | | |
|---|---|---|---|---|
| 5.1 | Spray dryer and accessory | $10,603,876.25 | $33,074 | $16,289,889 |
| | Subtotal | $10,603,876 | $33,074 | $16,289,889 |

Activation

| | | | | |
|---|---|---|---|---|
| 6.1 | Rotary kiln, chemical activation | $5,003,166 | $33,074 | $8,168,860 |
| 6.2 | Rotary kiln, physical activation | $8,338,611 | $33,074 | $13,005,254 |
| | Subtotal | $13,341,777 | $66,148 | $21,174,114 |
| | Total Investment Cost | $28,130,840 | $228,486 | $47,105,788 |

TABLE 4
Production cost for sorbent manufacturing process.

| | |
|---|---|
| Plant Capacity, % | 85 |
| Total Annual Operation, hrs | 7,451 |
| Total As Spent Cost (TASC), $ | 98,256,000 |
| Fixed Rate Charge (FRC), $ | 0.0886 |
| First Year Capital Charge, $ | 8,705,000 |
| First Year Fixed Operating Costs, $ | 7,492,000 |
| First-Year Variable Operating Costs, $ | 67,500,000 |
| First Year Fuel Costs, $ | 13,263,000 |
| Total Annual Cost, $ | 96,960,000 |
| Annual adsorbent Production, tonne | 75,000 |
| Adsorbent sale price ($/tonne) | 1,293 |

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

A method for capturing CO₂ includes mixing pulverized coal in an alkali solution to produce a solution comprising humic acid, an alkali, and water, and capturing CO₂ according to a process comprising at least one of: (1) spray drying the solution with CO₂-containing gases to produce a solid carbonated sorbent comprising humic acid and carbonated alkali, (2) spray drying the solution with inert gas to produce a sorbent comprising humic acid and alkali species, and contacting the sorbent with CO₂-containing gases, and (3) spray drying the solution with inert gas to produce the sorbent, chemically activating the sorbent to produce an activated sorbent, and contacting the activated sorbent with CO₂-containing gases.

The method of the preceding paragraph can optionally include, additionally and/or alternatively, any one or more of the following features, configurations, additional components, and/or steps:

In an embodiment of the preceding method, the alkali can be potassium carbonate.

In an embodiment of any of the preceding methods, capturing the CO₂ includes spray drying the solution with CO₂-containing gases to produce the solid carbonated sorbent.

An embodiment of the preceding method can further include regenerating the solution, wherein regenerating comprises heating the solid carbonated sorbent to release CO₂.

In an embodiment of any of the preceding methods, capturing the CO₂ includes one of: spray drying the solution to produce the sorbent and contacting the sorbent with CO₂, and spray drying the solution to produce the sorbent, chemically activating the sorbent to produce an activated sorbent, and contacting the activated sorbent with CO₂.

In an embodiment of any of the preceding methods, the sorbent can have a particle size within the range of 0.5 to 5 microns.

In an embodiment of any of the preceding methods, heated air or inert gas can be delivered to the chamber with the solution, the heated air having a temperature within the range of 175 to 225 degrees Celsius.

In an embodiment of any of the preceding methods, capturing the CO₂ can include spray drying the solution to produce the sorbent, chemically activating the sorbent to produce the activated sorbent, and contacting the activated sorbent with CO₂, and wherein the activated sorbent has a CO₂ adsorption capacity of at least 2.5-4 mmol/g activated sorbent.

In an embodiment of any of the preceding methods, chemically activating the sorbent can include heating the sorbent to a temperature of approximately 730-770 degrees C.

In an embodiment of any of the preceding methods, chemically activating the sorbent can include heating the sorbent to a final temperature of approximately 750 degrees Celsius and holding the temperature at approximately 750 degrees Celsius for at least 2 hours.

An embodiment of any of the preceding methods can further include cooling the sorbent to approximately 25° C. and reheating the sorbent in a stream of CO₂.

In an embodiment of any of the preceding methods, reheating can be conducted at temperature of approximately 750 degrees Celsius and holding the temperature at approximately 750 degrees Celsius for at least 1 hour.

An embodiment of any of the preceding methods can further include heating the activated sorbent following CO₂ capture to release CO₂ and regenerate the activated sorbent.

An embodiment of any of the preceding methods can further include heating the sorbent following CO₂ capture to release CO₂ and regenerate the sorbent.

An embodiment of any of the preceding methods can further include humidifying the sorbent or the activated sorbent prior to contacting the sorbent or the activated sorbent with CO₂.

In another aspect, a method of producing a solid sorbent for CO₂ capture includes mixing pulverized coal in an alkali solution to produce a solution, the solution comprising humic acid, an alkali, and water, and spray drying the solution to produce a sorbent comprising humic acid and alkali species, wherein the sorbent has a CO₂ adsorption capacity of at least 2.5 mmol/g activated sorbent.

The method of the preceding paragraph can optionally include, additionally and/or alternatively, any one or more of the following features, configurations, additional components, and/or steps:

In an embodiment of the preceding method, the alkali is potassium carbonate.

An embodiment of any of the preceding methods can further include chemically activating the sorbent to produce an activated sorbent having a CO₂ adsorption capacity of at least 4 mmol/g activated sorbent.

In an embodiment of any of the preceding methods, chemically activating the sorbent can include heating the sorbent to a temperature of approximately 730-770° C.

In an embodiment of any of the preceding methods, chemically activating the sorbent comprises heating the sorbent at temperature of approximately 750 degrees Celsius and holding the temperature at approximately 750 degrees Celsius for at least 1 hour.

An embodiment of any of the preceding methods can further include cooling the sorbent to approximately 25° C. and reheating the sorbent in a stream of CO₂.

In an embodiment of any of the preceding methods, the sorbent is hollow.

In an embodiment of any of the preceding methods, the sorbent has a mean particle size within the range of 0.5 to 5 microns.

In an embodiment of any of the preceding methods, spray drying comprises atomizing the solution in a chamber; wherein the solution has a potassium carbonate concentration of approximately 0.3 mol/L.

In an embodiment of any of the preceding methods, heated air is delivered to the drying vessel with the solution, the heated air having a temperature within the range of 175 to 225 degrees Celsius.

1. A method for capturing CO₂, the method comprising:
mixing pulverized coal in an alkali solution to produce a solution, the solution comprising humic acid, an alkali, and water; and
capturing CO₂ according to a process comprising at least one of:
spray drying the solution with CO₂-containing gases to produce a solid carbonated sorbent comprising humic acid and carbonated alkali;
spray drying the solution with inert gas to produce a sorbent comprising humic acid and alkali species, and contacting the sorbent with CO₂-containing gases; and
spray drying the solution with inert gas to produce the sorbent, chemically activating the sorbent to produce an activated sorbent, and contacting the activated sorbent with CO₂-containing gases.

2. The method of claim 1, wherein the alkali is potassium carbonate.

3. The method of claim 2, wherein capturing the CO₂ comprises spray drying the solution with CO₂-containing gases to produce the solid carbonated sorbent.

4. The method of claim 3, and further comprising regenerating the solution, wherein regenerating comprises heating the solid carbonated sorbent to release CO₂.

5. The method of claim 2, wherein capturing the CO₂ comprises one of:
spray drying the solution to produce the sorbent and contacting the sorbent with CO₂; and
spray drying the solution to produce the sorbent, chemically activating the sorbent to produce an activated sorbent, and contacting the activated sorbent with CO₂.

6. The method of claim 5, wherein the sorbent has a particle size within the range of 0.5 to 5 microns.

7. The method of claim 5, wherein spray drying comprises atomizing the solution in a drying vessel; wherein the solution has a potassium carbonate concentration between 0.1-0.4 mol/L.

8. The method of claim 7, wherein heated air or inert gas is delivered to the chamber with the solution, the heated air having a temperature within the range of 175 to 225 degrees Celsius.

9. The method of claim 5, wherein capturing the CO₂ comprises spray drying the solution to produce the sorbent, chemically activating the sorbent to produce the activated sorbent, and contacting the activated sorbent with CO₂, and wherein the activated sorbent has a CO₂ adsorption capacity of at least 2.5-4 mmol/g activated sorbent.

10. The method of claim 9, wherein chemically activating the sorbent comprises heating the sorbent to a temperature of approximately 730-770 degrees Celsius.

11. The method of claim 9, wherein chemically activating the sorbent comprises heating the sorbent to a final temperature of approximately 750 degrees Celsius and holding the temperature at approximately 750 degrees Celsius for at least 2 hours.

12. The method of claim 10, and further comprising cooling the sorbent to approximately 25° C. and reheating the sorbent in a stream of CO₂.

13. The method of claim 12, wherein reheating is conducted at temperature of approximately 750 degrees Celsius and holding the temperature at approximately 750 degrees Celsius for at least 1 hour.

14. The method of claim 11, and further comprising heating the activated sorbent following CO₂ capture to release CO₂ and regenerate the activated sorbent.

15. The method of claim 5, and further comprising heating the sorbent following CO₂ capture to release CO₂ and regenerate the sorbent.

16. The method of claim 5, and further comprising humidifying the sorbent or the activated sorbent prior to contacting the sorbent or the activated sorbent with CO₂.

17. A method of producing a solid sorbent for CO₂ capture, the method comprising:
mixing pulverized coal in an alkali solution to produce a solution, the solution comprising humic acid, an alkali, and water; and
spray drying the solution to produce a sorbent comprising humic acid and alkali species, wherein the sorbent has a CO₂ adsorption capacity of at least 2.5 mmol/g activated sorbent.

18. The method of claim 17, wherein the alkali is potassium carbonate.

19. The method of claim 18, and further comprising chemically activating the sorbent to produce an activated sorbent having a CO₂ adsorption capacity of at least 4 mmol/g activated sorbent.

20. The method of claim 19, wherein chemically activating the sorbent comprises heating the sorbent to a temperature of approximately 730-770 degrees Celsius.

21. The method of claim 19, wherein chemically activating the sorbent comprises heating the sorbent at temperature of approximately 750 degrees Celsius and holding the temperature at approximately 750 degrees Celsius for at least 1 hour.

22. The method of claim 20, and further comprising cooling the sorbent to approximately 25° C. and reheating the sorbent in a stream of CO₂.

23. The method of claim 20, wherein the sorbent is hollow.

24. The method of claim 23, wherein the sorbent has a mean particle size within the range of 0.5 to 5 microns.

25. The method of claim 20, wherein spray drying comprises atomizing the solution in a chamber; wherein the solution has a potassium carbonate concentration of approximately 0.3 mol/L.

26. The method of claim 25, wherein heated air is delivered to the drying vessel with the solution, the heated air having a temperature within the range of 175 to 225 degrees Celsius.
